(19) United States
(12) Patent Application Publication
(10) Pub. No.: US 2009/0143935 A1
(43) Pub. Date: Jun. 4, 2009

(54) REMOTE MONITORING SYSTEM FOR A BATTERY MODULE OF AN ELECTRIC VEHICLE

(76) Inventor: Alan Hsu, Taipei Hsien (TW)

Correspondence Address: Alan Hsu;235 Chung - Ho, Box 8-24, Taipei, TW

(21) Appl. No.: 12/046,472

(22) Filed: Mar. 12, 2008

(30) Foreign Application Priority Data
Nov. 30, 2007 (TW) 096220357

(51) Int. Cl. B60L 11/00

(52) U.S. Cl. 701/33

(57) ABSTRACT

A remote monitoring system for a battery module of an electric vehicle timely monitors the battery module of the electric vehicle mainly through a detection recorder provided in the electric vehicle. The detection recorder records the physical and electrical variables of the battery module and sends the data to the remote system through a communication unit. If the recorded data contains an abnormal condition of the battery module, the remote system wirelessly sends a signal through the telecommunication equipment; for example, through a wireless base station, a message telling a fault is sent to the receiving end of the user who in advance registers, reminding the user of overhauling the vehicle as soon as possible or inform the user of the vehicle's condition for the car owner's driving safety.

### BACKGROUND OF THE INVENTION

1. Field of the Invention

This invention relates to a remote monitoring system and particularly to a monitoring system that timely detects and monitors a battery module of an electric vehicle and may send a message to a specific receiving end.

2. Description of Related Art

An electric vehicle, such as a pure electric vehicle and a gas/electric hybrid vehicle, is mainly powered by a battery module as a power source. Owning to a vehicle running, the service time, number of times of charging and discharging, environment variable, or original manufacturing flaws of the battery module reduces the durability of battery module or a battery cell, causing it to be in seriousness; the vehicle's extreme speed, accelerating force, and durability are vitally related to the performance of battery and even cause the power supply to be interrupted or cause the battery to explode. Thus, a regular health examination on the power supply system, and battery module maintenance for an optimum behavior are very important to safe electric vehicle driving.

However, consumptive parts are not installed in the electric vehicle as those in a motor vehicle that must be replaced periodically or in a definite mile, and thus a maintenance period of the electric vehicle is longer so that a user who drives for a long time lacks self-knowledge of the bad condition of battery module and exposed to a dangerous traffic status with others, thereby facing a serious aftereffect in case of immodesty. Thus, the electric vehicle certain will be a substitute, so it is necessary to well control its power source.

Consequently, because of the technical defects of described above, the applicant keeps on carving unflaggingly through wholehearted experience and research to develop the present invention, which can effectively improve the defects described above.

### SUMMARY OF THE INVENTION

It is an objective of this invention to provide remote monitoring system for a battery module provided in an electric vehicle. Monitoring the battery module in different conditions, the remote monitoring system wirelessly sends a signal, such as a sentence or phrase that, for example, the vehicle must be examined and repaired as soon as possible, or a message telling the vehicle's current condition, to a receiving end of a user who in advance registers directly/indirectly through a unit of telecommunication equipment.

It is a further objective of this invention to actively monitor the battery module of the electric vehicle circularly and collect data regarding related physical and electrical characteristics of the battery module as a basis of overhaul.

It is a further objective of this invention to in advance acknowledge a poor condition of the battery module and then give an abnormality warning at the first time, preventing the user from staying in the dangerous driving condition when the power system fails and even from having a traffic accident.

To achieve above object, the present invention provides a 1.A remote monitoring system for a battery module provided in an electric vehicle, monitoring the battery module provided in the electric vehicle through a detection recorder and sending a detection signal, comprising: a detection recorder provided in the electric vehicle to monitor the battery module in the electric vehicle, record physical and electrical variables of the battery module, and send data comprising the physical and electrical variables; a control unit electrically connected to the detection recorder to control and send the data containing the physical variable; a communication unit provided with an emitter that sends a signal converted from the data sent by the control unit; thus, the signal sent by the communication unit serving as a basis on which the remote system reminds the vehicle's user of overhauling as soon as possible or tells the user the vehicle's condition for the car owner's driving safety.

Moreover the present invention provides a remote monitoring system for a battery module provided in an electric vehicle, monitoring the battery module provided in the electric vehicle through a detection recorder and sending a detection signal, comprising: at least one electric vehicle, comprising a detection recorder monitoring the battery module in the electric vehicle, recording physical and electrical variables of the battery module, and sending data containing the physical and electrical variables; a control unit electrically connected to the detection recorder to control and send the data containing the physical and electrical variables; a communication unit provided with an emitter that sends a signal converted from the data sent by the control unit; at least one base station receiving and sending the signal transmitted by the communication unit; a remote monitoring center receiving and replying a signal transmitted by the base station; thus, the signal sent by the communication unit, through the base station, serving as a basis on which the remote system reminds the vehicle's user of overhauling as soon as possible or tells the user the vehicle's condition for the car owner's driving safety.

In this invention, a technical solution to the issues is described below.

The remote monitoring system for the battery module of the electric vehicle according to this invention timely monitors the battery module of the electric vehicle mainly through a detection recorder provided in the electric vehicle. The physical and electrical variation of the battery module is recorded for monitoring, and the remote monitoring system is formed with a control end, a relay end, and the receiving end that match with each other.

The data in the detection recorder is sent to the remote system through a communication unit built in the vehicle. If the recorded data contains an abnormal condition of the battery module, the remote system wirelessly sends a signal through the telecommunication equipment; for example, through a wireless base station, a message telling a fault is sent to the receiving end of the user who in advance registers, reminding the user of overhauling the vehicle as soon as possible or inform the user of the vehicle's condition for the car owner's driving safety.

The detection recorder may monitor the battery module for the physical and electrical variation that currently may comprises, but not limited to: (1) charged and discharged voltage and current as the electrical characteristics; (2) a working temperature during charging and discharging; (3) numerical data regarding an internal impedance in the battery.

Virtues collocated with those of the prior arts are described below.
1. The probability of instant damage of the battery module in an outdoor environment and during driving is reduced, making the user to be free from worry.
2. In a mobile communication technology matching with the remote monitoring system, the electric vehicle is monitored at any time for an electric power condition and a related message is instantly given for assurance of a maintenance occasion.

However, in the description mentioned above, only the detailed description and drawings of the embodiments according to this invention are provided without limit to this invention and the characteristics of this invention; all those skilled in the art without exception should include the equivalent changes and modifications as falling within the true scope and spirit of the present invention.

### BRIEF DESCRIPTION OF THE DRAWINGS

FIG. 1 is a schematic view illustrating a concept of this invention; and

FIG. 2 is a schematic view illustrating a system in a preferred embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

In this invention, a battery module supplying a power is mainly provided in an electric vehicle. Regarding the battery module, a plurality of monomer charging cell (nickel, lithium, and lithium-ferroelectric cells) may firstly combined into a unit cell; for example, a 4×4 matrix is arranged and the plurality of unit cells are gathered and arranged to form a battery module, and 800 16×50 monomer charging cells supply a regular voltage and a regular current through a charger to charge the battery module.

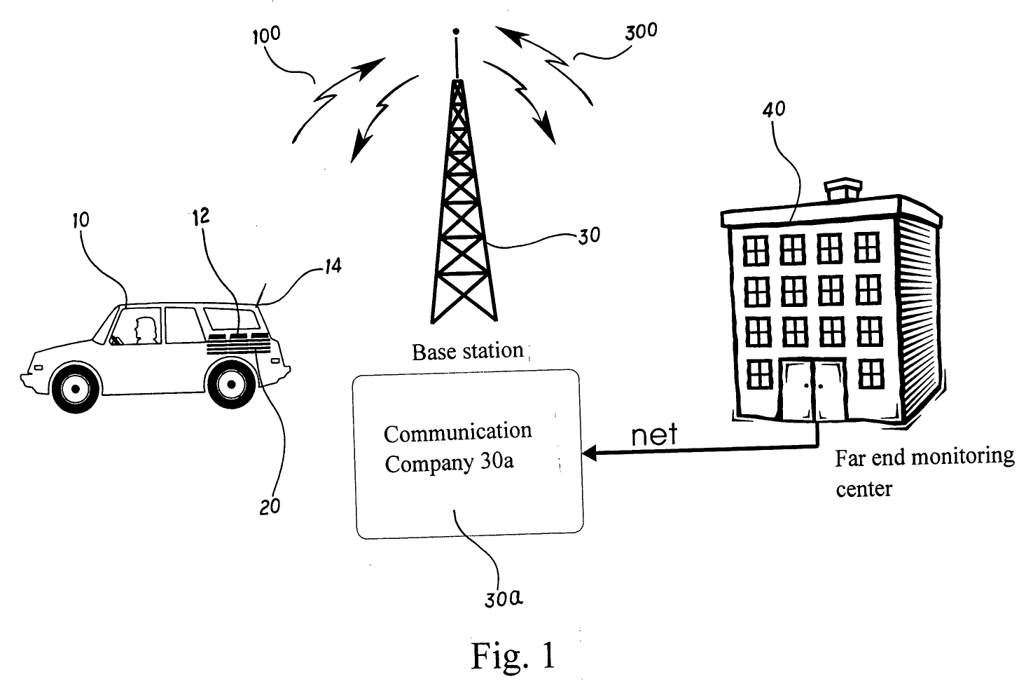

Refer to FIG. 1 illustrating a concept of this invention. A battery module 20 is provided in the electric vehicle 10. The battery module 20 is electrically connected to a detection recorder 12 in the electric vehicle 10, so the detection recorder 12 may instantly monitor the battery module 20 in the electric vehicle 10 and recorder the physical and electrical variation of the battery module 20, and a message including the status of battery may be transmitted through a built-in communication unit 14 depending on a condition and a setting. In the description and what is made below, the electric vehicle 10 is generally one that may transmit out a signal 100 regarding the status of battery module 20 through the communication unit 14.

A telecom operator 30a may receive the signal transmitted by the communication unit 14 in the electric vehicle 10 through the base station 30 and then determine the signal 100 for a follow-up treatment; for example, the signal 100 is directly read and a reply for the signal 100 is made to the electric vehicle 10 or is converted into another signal 300 that is transmitted to the remote monitoring center 40.

Refer to FIG. 2 illustrating a system in a preferred embodiment of this invention. The electric vehicle 10 mainly comprises a sectional battery module 20, a detection recorder 12, and a communication unit 14 to monitor the battery module and control the transmitted signal. Further, the battery module 20 is composed of a plurality of monomer charging cell. The detection recorder 12 is electrically connected to a control unit 16. The control unit 16 is controlled by a switch unit 162 and outputs a status data to a display element 164. The switch unit 162 may set up a working occasion of the control unit 16. The communication unit 14 comprises an emitter 140 and a receiver 142.

The battery module 20 is controlled by a control unit 16 through the detection recorder 12; for example, a random manner of sequence, matrix, and timing is used to detect each monomer charging cell for obtaining a random group of options of discharged and charged voltage and current as electrical characteristics, a working temperature during charging and discharging, and numerical data regarding an internal impedance in the battery, and then send the data including the physical and electrical variables. The data is a real-time or historical numerical value and variable that is sent to the control unit 16. At this stage, the obtained data may be in advance compared with a standard numerical value to determine whether a next step proceeds. Besides, the given data may be converted into the signal 100 and then sent by the emitter 140 through the communication unit 14. Through predetermined settings, the signal 100 may be sent out at different points of time that are divided into the points of time of instant transfer, fixed-time transfer, and conditional transfer.

The signal 100 sent by the communication unit 14 carries the electric vehicle's ID code. From the ID code, a sender and a message receiver for a subsequent treatment are apparent. Integrating the General Packet Radio Service (GPRS) is a better option for nowadays telecommunication. In this invention, data may be currently transferred by means of the communication protocol. Through the base station 30, the telecom operator 30a receives the signal 100 sent by the communication unit 14 in the electric vehicle, and the remote monitoring center 40 synchronously receives a signal 300. When the signal 300 indicates that the battery module 20 is normal, it may be neglected by setting or the remote monitoring center 40 may inform and ask the telecom operator 30a of the base station 30 to send a normality reply signal 302, and an instant and timing message is sent to the register 32 of electric vehicle and a related person, for example, through a handheld device, a mobile phone, vehicle-based communication device. Alternatively, a signal 302a may be sent to a receiver 142 of the communication unit 14 in the electric vehicle, indicating the signal 302a that is shown on a display unit 164 to hint the vehicle user.

Oppositely, when the signal 100 indicates that the battery module 20 is abnormal, similarly, the remote monitoring center 40 may inform and ask the telecom operator 30a of the base station 30 to send a abnormality reply signal 302, and an instant and timing message is sent to the register 32 of electric vehicle and a related person to overhaul as soon as possible. Similarly, a signal 302a may be sent to a receiver 142 of the communication unit 14 in the electric vehicle, indicating the signal 302a that is shown on a display unit 164 to hint the vehicle user. The status and mileage durability of the battery module 20 may also be included in the message 302a for maintenance of vehicle driving safety.

The signal sent by the remote monitoring center 40 is not limited to a content. Through the software that is edited and set, the electric vehicle may be identified for a maintenance period prompted by the remote monitoring center 40.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A remote monitoring system for a battery module provided in an electric vehicle, monitoring the battery module provided in the electric vehicle through a detection recorder and sending a detection signal, comprising:
a detection recorder provided in the electric vehicle to monitor the battery module in the electric vehicle, record physical and electrical variables of the battery module, and send data comprising the physical and electrical variables;
a control unit electrically connected to the detection recorder to control and send the data containing the physical variable;
a communication unit provided with an emitter that sends a signal converted from the data sent by the control unit;
thus, the signal sent by the communication unit serving as a basis on which the remote system reminds the vehicle's user of overhauling as soon as possible or tells the user the vehicle's condition for the car owner's driving safety.

2. The remote monitoring system for a battery module provided in an electric vehicle according to claim 1, wherein the control unit controls the detection recorder in a manner of sequence, matrix, and timing to detect each monomer charging cell.

3. The remote monitoring system for a battery module provided in an electric vehicle according to claim 1, wherein the data of physical and electrical variables of the control unit comprises a random group of options of discharged and charged voltage and current as electrical characteristics, a working temperature during charging and discharging, and numerical data regarding an internal impedance variation in the battery.

4. The remote monitoring system for a battery module provided in an electric vehicle according to claim 1, wherein the signal converted by the communication unit is sent by the emitter in a random manner of instant transfer, fixed-time transfer, or conditional transfer.

5. The remote monitoring system for a battery module provided in an electric vehicle according to claim 1, wherein the control unit is controlled by a switch unit and may output a status data to a display element.

6. The remote monitoring system for a battery module provided in an electric vehicle according to claim 5, wherein the switch unit serves as a working occasion to set up the control unit.

7. A remote monitoring system for a battery module provided in an electric vehicle, monitoring the battery module provided in the electric vehicle through a detection recorder and sending a detection signal, comprising:
at least one electric vehicle, comprising
a detection recorder monitoring the battery module in the electric vehicle, recording physical and electrical variables of the battery module, and sending data containing the physical and electrical variables;
a control unit electrically connected to the detection recorder to control and send the data containing the physical and electrical variables;
a communication unit provided with an emitter that sends a signal converted from the data sent by the control unit;
at least one base station receiving and sending the signal transmitted by the communication unit;
a remote monitoring center receiving and replying a signal transmitted by the base station;
thus, the signal sent by the communication unit, through the base station, serving as a basis on which the remote system reminds the vehicle's user of overhauling as soon as possible or tells the user the vehicle's condition for the car owner's driving safety.

8. The remote monitoring system for a battery module provided in an electric vehicle according to claim 7, wherein the control unit controls the detection recorder in a manner of sequence, matrix, and timing to detect each monomer charging cell.

9. The remote monitoring system for a battery module provided in an electric vehicle according to claim 7, wherein the data of physical and. electrical variables of the control unit comprises a random group of options of discharged and charged voltage and current as electrical characteristics, a working temperature during charging and discharging, and numerical data regarding an internal impedance variation in the battery.

10. The remote monitoring system for a battery module provided in an electric vehicle according to claim 7, wherein the signal converted by the communication unit is sent by the emitter in a random manner of instant transfer, fixed-time transfer, or conditional transfer.

11. The remote monitoring system for a battery module provided in an electric vehicle according to claim 7, wherein the control unit is controlled by a switch unit and may output a status data to a display element.

12. The remote monitoring system for a battery module provided in an electric vehicle according to claim 11, wherein the switch unit serves as a working occasion to set up the control unit.

13. The remote monitoring system for a battery module provided in an electric vehicle according to claim 7, wherein when the signal received by the base station indicates that the battery module is normal, it may be neglected by setting.

14. The remote monitoring system for a battery module provided in an electric vehicle according to claim 7, wherein the base station receives the signal from the battery module and the remote monitoring center informs and asks the base station to send a reply signal to the electric vehicle's register.
